(19) United States
(12) Patent Application Publication
(10) Pub. No.: US 2012/0174030 A1
(43) Pub. Date: Jul. 5, 2012

(54) NAVIGATING AMONG HIGHER-LEVEL AND LOWER-LEVEL WINDOWS ON A COMPUTING DEVICE

(75) Inventors: Nirmalya Barat, Sunnyvale, CA (US); Brian M. Collins, South San Francisco, CA (US); Ansuman Tapan Satpathy, Sunnyvale, CA (US)

(73) Assignee: MOTOROLA-MOBILITY, INC., Libertyville, IL (US)

(21) Appl. No.: 12/980,384

(22) Filed: Dec. 29, 2010

(51) Int. Cl. G06F 3/048

(52) U.S. Cl. 715/802

(57) ABSTRACT

Disclosed are methods for consistent navigation among higher-level and lower-level windows on a device's display screen. A user can consistently navigate from one higher-level window to another and use the same navigation tools to navigate among the lower-level windows (if any) within a higher-level window. Some embodiments present a set of small “overviews” to the user. Each overview corresponds to one of the higher-level windows. In addition to the set of overviews, a larger “preview” can be shown of the window with focus. If the window with focus contains lower-level windows, then the preview can include “snapshots” of those lower-level windows. In some embodiments, a “title bar” provides more information about the window with focus, such as the title of that window. When a lower-level window is currently active within the higher-level window with focus, the title bar can show information about that active lower-level window.

### FIELD OF THE INVENTION

The present invention is related generally to computing devices and, more particularly, to visually displaying information on a computing device.

### BACKGROUND OF THE INVENTION

Once personal computing devices became multi-tasking, a problem arose as to how a device's user could keep track of everything that the device was doing. The user may, for example, have opened a spreadsheet program and a word processor, while the device is simultaneously receiving and displaying information from multiple feeds and presenting its own status.

Various operating systems attempt to address this problem by providing multiple windows on the device's display screen, where each window displays information from only one application. (Here, “applications” include just about anything that can provide information on the device's display screen including utility programs provided by the operating system.) Some applications, especially Internet browsers, can open their own sub-windows (often called “tabs”) within the window provided for the application by the operating system. For the user, managing multiple windows is usually much easier than managing multiple streams of information not divvied up into separate windows. The user can select one window (or one sub-window) and focus on the information within that window. The operating system and applications provide mechanisms when the user wishes to change his focus from one window or sub-window to another.

However, there are inconsistencies in this architecture than can confuse and slow down the user. In particular, the “higher-level” windows are provided by the operating system which also provides mechanisms for navigating among these windows. Each sub-window (or “lower-level” window) is provided by its host application which, of course, also provides mechanisms for navigating among the sub-windows within one higher-level window. When a user invokes a number of applications simultaneously, there is no reason to expect that the navigational mechanisms provided by those applications will be consistent with each other or with the operating system.

### BRIEF SUMMARY

The above considerations, and others, are addressed by the present invention, which can be understood by referring to the specification, drawings, and claims. According to aspects of the present invention, a method provides consistent navigation among higher-level and lower-level windows on a device's display screen. A user can consistently navigate from one higher-level window to another and use the same navigation tools to navigate among the lower-level windows (if any) within a higher-level window.

To help the user keep track of all open windows, some embodiments present a set of small “overviews” to the user. Each overview corresponds to one of the higher-level windows, and the overview of the window with focus is highlighted in some manner. In addition to the set of overviews, a larger “preview” can be shown of the window with focus. If the window with focus contains lower-level windows, then the preview can include “snapshots” of those lower-level windows.

In some embodiments, a “title bar” provides more information about the window with focus, such as the title of that window. When a lower-level window is currently active within the higher-level window with focus, the title bar can show information about that active lower-level window.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a generalized schematic of a representational device in which the present invention may be practiced;

FIGS. 2a, 2b, and 2c together form a flowchart of a method for consistent navigation among higher-level and lower-level windows; and

FIGS. 3a and 3b are exemplary screen shots illustrating the output of an embodiment of the present invention.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

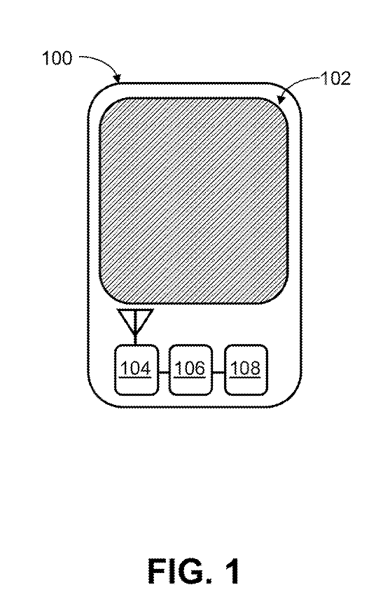

FIG. 1 shows a representative computing device 100 (e.g., a cellular telephone, personal digital assistant, or personal computer) that incorporates an embodiment of the present invention. FIG. 1 shows the device 100 as a cellular telephone presenting its main display screen 102 to its user. Typically, the main display 102 is used for most high-fidelity interactions with the user. For example, the main display 102 is used to show video or still images, is part of a user interface for changing configuration settings, and is used for viewing call logs and contact lists. To support these interactions, the main display 102 is of high resolution and is as large as can be comfortably accommodated in the device 100. In some situations, it would be useful for the user to have access to a display screen even larger than the main display 102. For these situations, a larger external display can be connected to, and controlled by, the computing device 100 (e.g., through a docking station). The device 100 may have a second and possibly a third display screen for presenting status messages. These screens are generally smaller than the main display screen 102. They can be safely ignored for the remainder of the present discussion.

The typical user interface of the computing device 100 includes, in addition to the main display 102, a keypad and other user-input devices. The keypad may be physical or virtual, involving virtual keys displayed on a touch screen 102.

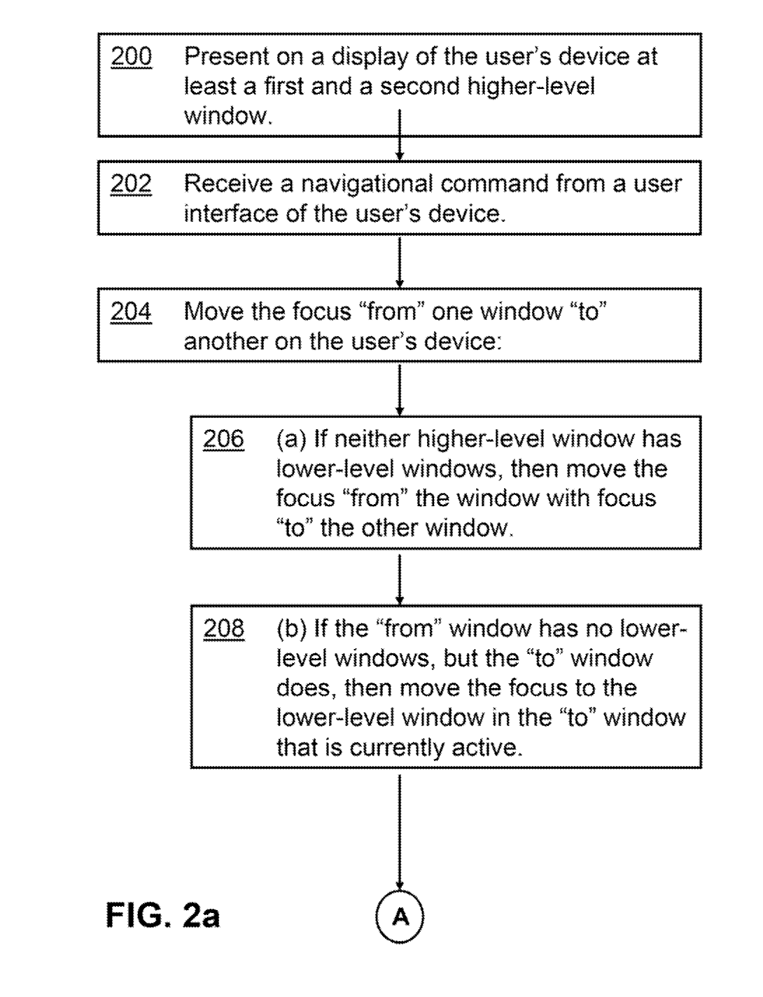

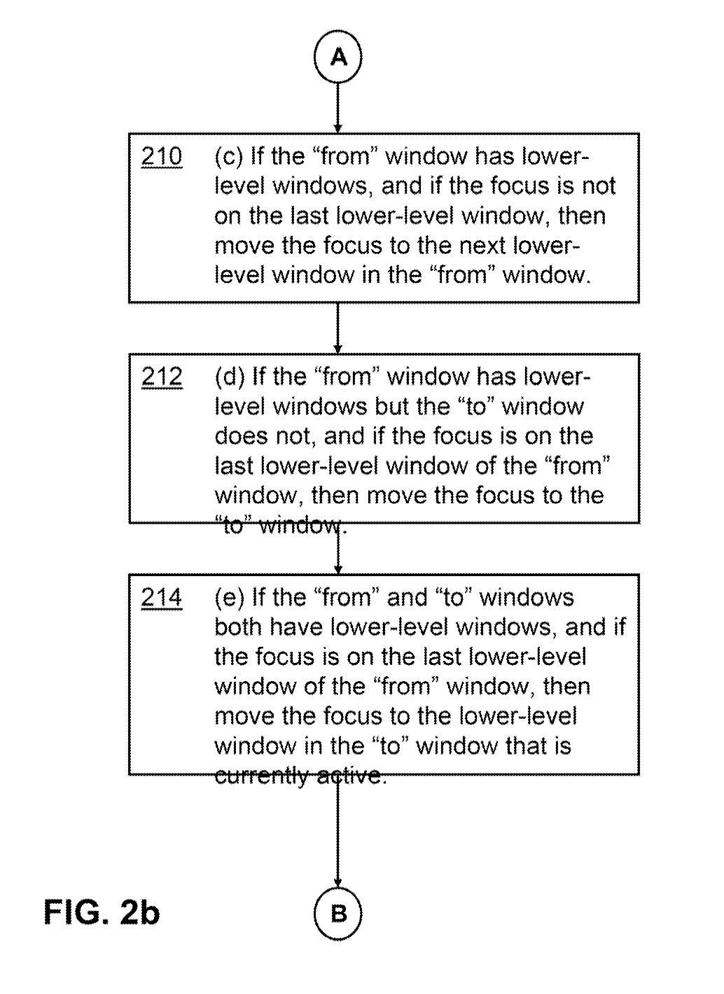

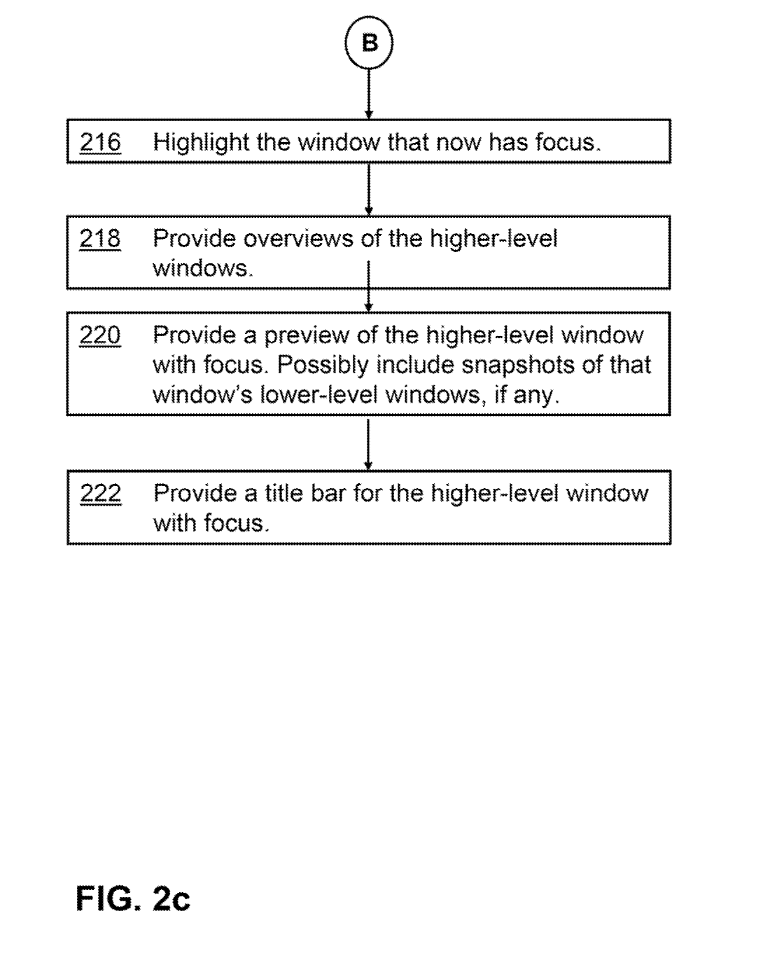

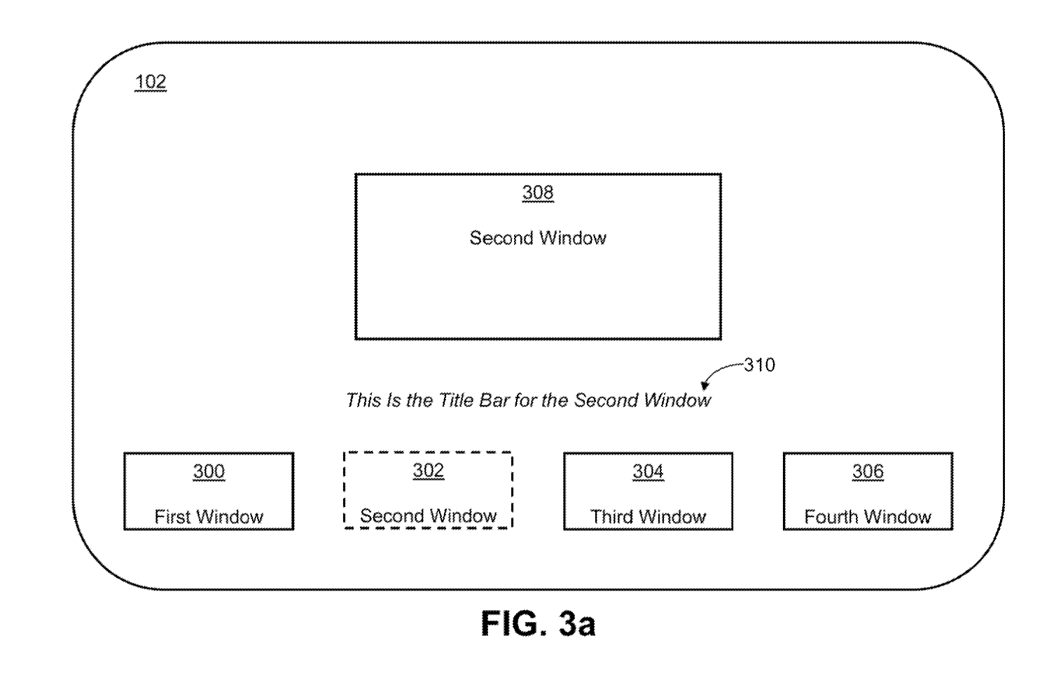

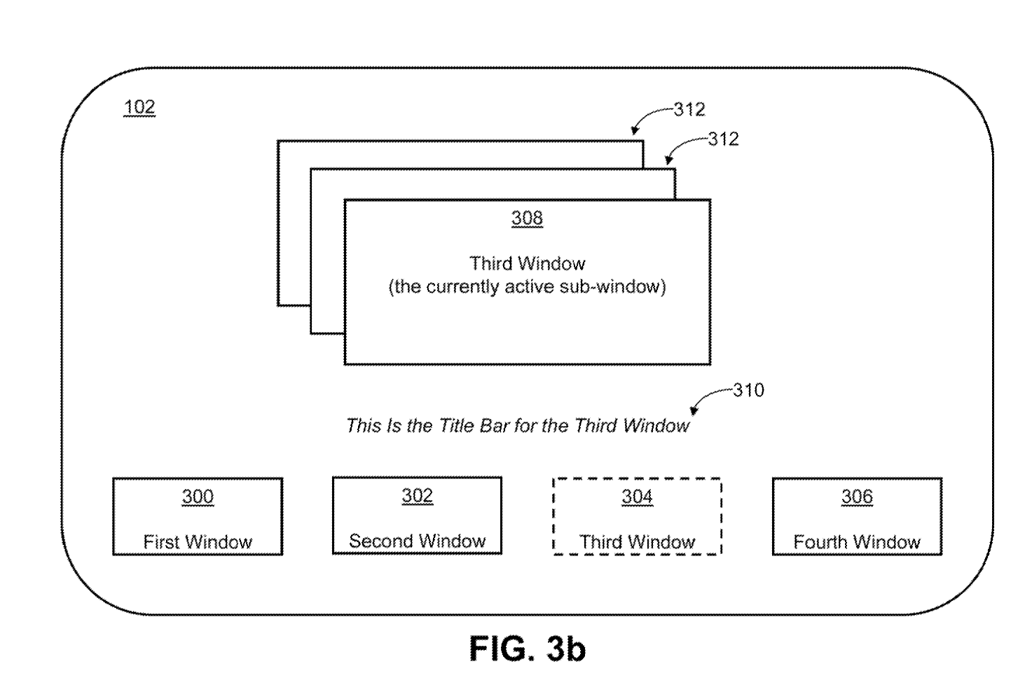

FIG. 1 illustrates some of the more important internal components of the computing device 100. The network interface 104 sends and receives media presentations, related information, and download requests. The processor 106 controls the operations of the device 100 and, in particular, supports aspects of the present invention as illustrated in FIGS. 2 and 3, discussed below. The processor 106 uses the memory 108 in its operations. Specific uses of these components by specific devices are discussed as appropriate below.

The method of FIGS. 2a, 2b, and 2c begins in step 200 where the computing device 100 displays a number of windows on a display screen. While the screen may be the main display 102, this method is also useful for larger screens, such as an external display run by the device 100.

Each displayed window could be presented by the operating system of the computing device 100, by a utility program, or by an application program (such as a browser). The methods of the present invention may be particularly useful when windows of different origins are displayed simultaneously. The set of windows displayed could include both higher-level and lower-level windows.

Note that the presenter (e.g., operating system, utility, application, browser) of a set of windows defines a particular order for the windows it is presenting. Thus, it makes sense to describe the “next” window or the “previous” window with respect to the window that currently has focus or the window that is currently active. The ordering is generally temporal, that is, each new window is assigned a location in the order “after” all of the windows that are already being presented by this particular presenter. However, the methods of the present invention are applicable regardless of how the presenters define the order of their windows.

Generally, at a given time only one window will have the focus. When a higher-level window includes a number of lower-level windows, generally only one of those lower-level windows will be active at one time.

FIG. 3a presents an example of windows open on the main display 102 of the computing device 100. The details of FIG. 3a are discussed where appropriate below. For the moment, note that there are four higher-level windows 300, 302, 304, 306 open, and that the second window 302 has the focus. (Please ignore window 308 for the moment. It is discussed below.)

In step 202 of FIG. 2a, the computing device 100 receives a navigational command via its keyboard interface. The command is called a “single forward” or a “single back” navigational command. Here, “single” simply means that the command is effective in all of the substeps (206 through 214) of step 204. The command can be a predefined keystroke or a predefined set of keystrokes. For example, a right arrow or Alt-Tab can be defined as the single forward navigational command, and a left arrow or Shift-Alt-Tab can be defined as the single back navigational command.

In any case, the computing device 100 responds to the navigational command (forward or back) received in step 202 by moving the focus from the current window to another window (step 204). Because the specifics of moving the window focus vary with the starting situation, step 204 is divided into five substeps (206 through 214). Each substep of step 204 defines the method of moving the window focus for a specific starting situation.

Substep 206 is a simple situation where a higher-level window has the focus, where this higher-level window has no lower-level windows, and where the “next” higher-level window also has no lower-level windows. (Note that which window is “next” depends upon both the window order as assigned by the window presenter and by which command, forward or back, is received in step 202.) In this simple situation, the focus is moved from the current higher-level window to the next higher-level window (forward or back as appropriate).

The situation of substep 208 is only slightly more complicated. Here, the “from” window (the window that currently has the focus) is again a higher-level window that has no lower-level windows, but the “to” higher-level window has at least two lower-level windows. According to substep 208, the focus is moved to the lower-level window (within the “to” higher-level window) that is currently active. This is the particular situation illustrated by FIGS. 3a and 3b. In FIG. 3a, the second higher-level window 302 originally has the focus. When a forward navigational command is received, the next higher-level window is the third higher-level window 304. That higher-level window 304 contains within itself three lower-level windows. In FIG. 3b, the focus is seen to have moved to the lower-level window (of those contained in the third higher-level window 304) that is currently active.

The situation of substep 210 of FIG. 2b is very straightforward. Here, the “from” higher-level window contains multiple lower-level windows, and the lower-level window with focus is not the last lower-level window in the “from” higher-level window. The focus simply moves to the next lower-level window in the “from” higher-level window. That is, the “to” higher-level window is the same as the “from” higher-level window, and the focus simply progresses from one lower-level window to the next within that higher-level window. (When the navigational command is a back command, then replace “not the last” in the above description with “not the first.”)

In substep 212, the “from” higher-level window contains a number of lower-level windows, the last lower-level window has the focus (for a back command, the first lower-level window has the focus), and the next higher-level window does not contain lower-level windows. Then the focus moves to the next higher-level window.

In the final situation, covered by substep 214, each of the “from” and “to” higher-level windows contains a number of lower-level windows. The focus is on the last lower-level window of the higher-level window (first for a back command). Then the focus moves, as in substep 208, to the currently active lower-level window in the “to” higher-level window.

The method presented above in substeps 206 through 214 of step 204 is a unified procedure for moving the focus among higher-level and lower-level windows, regardless of which presenter hosts each window. As such, it is easier to use than current methods where each window presenter can implement its own scheme for navigation among its own windows.

Steps 216 through 222 of FIG. 2c present optional steps that may, in some embodiments, help the user while navigating through the windows presented by the computing device 100. In step 216, highlighting is used to tell the user which window currently has the focus. In FIG. 3a, the dashed outline of the second window 302 shows that this window 302 currently has the focus. The focus moves, as is shown in FIG. 3b by the dashed outline now surrounding the third window 304. Of course, other methods than a dashed outline could be used for the highlighting such as a brightened border, a change in color or size, or decreased transparency.

In step 218, small overviews are provided for the currently open higher-level windows. These are illustrated in FIGS. 3a and 3b by the small overview windows 300 through 306 near the bottom of the display screen 102. Each overview window can display a smaller version of its full window counterpart or enough of that full window to make the full window's contents clear to the user. It would be advantageous to arrange these overview windows in order, such that, for example, the “next” window sits to the right of (or below) the current window.

In addition to the overview windows of step 218, step 220 displays a preview window. The preview is a larger version of the overview window, but in most embodiments only one preview is shown: This is a preview of the window that currently has focus. FIGS. 3a and 3b show the preview as window 308. In FIG. 3a, the higher-level window with focus (the second window 302) contains no lower-level windows, so the preview 308 can simply be a larger version of the overview window 302. In FIG. 3b, on the other hand, the higher-level window with focus (the third window 304) contains three lower-level windows. The preview 308 gives a full preview of the lower-level window that is currently active and shows snapshots of the other lower-level windows 312 behind the main preview. As the preview window 308 changes in response to the user's navigational commands, the preview window 308 serves as a useful guide to the user to know how to navigate among the higher-level and lower-level windows.

Step 222 adds an optional title bar 310 to the preview window 308. The title bar can include the name of the presenting application, an icon, and a textual description of the window as provided by the presenter of the window. For example, if the preview window 308 is showing a web page, then the title bar may include a title given to that page by the web host. Different presenters can present different textual information for the title bars of their windows

In view of the many possible embodiments to which the principles of the present invention may be applied, it should be recognized that the embodiments described herein with respect to the drawing figures are meant to be illustrative only and should not be taken as limiting the scope of the invention. For example, the invention may be used with any type of window presenter and may be incorporated into any type of display interface. Therefore, the invention as described herein contemplates all such embodiments as may come within the scope of the following claims and equivalents thereof.

We claim:

1. On a computing device comprising a display interface and a keyboard interface, a method for switching focus among windows, the method comprising:
displaying, via the display interface, a first higher-level window and a second higher-level window;
receiving, via the keyboard interface, a single forward navigational command; and
responding to the single forward navigational command, wherein responding comprises:
if the first higher-level window does not comprise a plurality of lower-level windows, if the second higher-level window does not comprise a plurality of lower-level windows, and if the first higher-level window has focus, then moving the focus to the second higher-level window;
else if the first higher-level window does not comprise a plurality of lower-level windows, if the second higher-level window comprises a plurality of lower-level windows, the lower-level windows of the second higher-level window ordered from first to last, and if the first higher-level window has focus, then moving the focus to a currently active lower-level window of the second higher-level window;
else if the first higher-level window comprises a plurality of lower-level windows, the lower-level windows of the first higher-level window ordered from first to last, and if a lower-level window of the first higher-level window other than the last lower-level window has focus, then moving the focus to a next lower-level window of the first higher-level window;
else if the first higher-level window comprises a plurality of lower-level windows, the lower-level windows of the first higher-level window ordered from first to last, if the second higher-level window does not comprise a plurality of lower-level windows, and if the last lower-level window of the first higher-level window has focus, then moving the focus to the second higher-level window;
else if the first higher-level window comprises a plurality of lower-level windows, the lower-level windows of the first higher-level window ordered from first to last, if the second higher-level window comprises a plurality of lower-level windows, the lower-level windows of the second higher-level window ordered from first to last, and if the last lower-level window of the first higher-level window has focus, then moving the focus to a currently active lower-level window of the second higher-level window.

2. The method of claim 1 wherein each window is presented to the display interface by an element selected from the group consisting of: an operating system, an application, a browser, and a utility program.

3. The method of claim 1 further comprising:
highlighting, via the display interface, a window that currently has the focus.

4. The method of claim 1 further comprising:
displaying, via the display interface, a plurality of overviews, wherein each overview is associated with a higher-level window.

5. The method of claim 1 further comprising:
before receiving the single forward navigational command, displaying, via the display interface, a first preview associated with a window that currently has focus;
wherein responding to the single forward navigational command further comprises:
ceasing to display the first preview; and
displaying, via the display interface, a second preview associated with the window to which focus is moved.

6. The method of claim 5 further comprising:
displaying, via the display interface, a title bar with information corresponding to the second preview.

7. The method of claim 5 wherein if the window to which focus is moved is a higher-level window that comprises a plurality of lower-level windows, then displaying the second preview comprises displaying snapshots of those lower-level windows.

8. On a computing device comprising a display interface and a keyboard interface, a method for switching focus among windows, the method comprising:
displaying, via the display interface, a first higher-level window and a second higher-level window;
receiving, via the keyboard interface, a single back navigational command; and
responding to the single back navigational command, wherein responding comprises:
if the second higher-level window does not comprise a plurality of lower-level windows, if the first higher-level window does not comprise a plurality of lower-level windows, and if the second higher-level window has focus, then moving the focus to the first higher-level window;
else if the second higher-level window does not comprise a plurality of lower-level windows, if the first higher-level window comprises a plurality of lower-level windows, the lower-level windows of the first higher-level window ordered from first to last, and if the second higher-level window has focus, then moving the focus to a currently active lower-level window of the first higher-level window;
else if the second higher-level window comprises a plurality of lower-level windows, the lower-level windows of the second higher-level window ordered from first to last, and if a lower-level window of the second higher-level window other than the first lower-level window has focus, then moving the focus to a previous lower-level window of the second higher-level window;
else if the second higher-level window comprises a plurality of lower-level windows, the lower-level windows of the second higher-level window ordered from first to last, if the first higher-level window does not comprise a plurality of lower-level windows, and if the first lower-level window of the first higher-level window has focus, then moving the focus to the second higher-level window;
else if the second higher-level window comprises a plurality of lower-level windows, the lower-level windows of the second higher-level window ordered from first to last, if the first higher-level window comprises a plurality of lower-level windows, the lower-level windows of the first higher-level window ordered from first to last, and if the first lower-level window of the second higher-level window has focus, then moving the focus to a currently active lower-level window of the first higher-level window.

9. The method of claim 8 wherein each window is presented to the display interface by an element selected from the group consisting of: an operating system, an application, a browser, and a utility program.

10. The method of claim 8 further comprising:
highlighting, via the display interface, a window that currently has the focus.

11. The method of claim 8 further comprising:
displaying, via the display interface, a plurality of overviews, wherein each overview is associated with a higher-level window.

12. The method of claim 8 further comprising:
before receiving the single back navigational command, displaying, via the display interface, a first preview associated with a window that currently has focus;
wherein responding to the single back navigational command further comprises:
ceasing to display the first preview; and
displaying, via the display interface, a second preview associated with the window to which focus is moved.

13. The method of claim 12 further comprising:
displaying, via the display interface, a title bar with information corresponding to the second preview.

14. The method of claim 12 wherein if the window to which focus is moved is a higher-level window that comprises a plurality of lower-level windows, then displaying the second preview comprises displaying snapshots of those lower-level windows.

15. A computing device configured for switching focus among windows, the computing device comprising:
a display interface configured for displaying a first higher-level window and a second higher-level window;
a keyboard interface configured for receiving a single forward navigational command; and
a processor operatively connected to the display interface and to the keyboard interface and configured for responding to the single forward navigational command, wherein responding comprises:
if the first higher-level window does not comprise a plurality of lower-level windows, if the second higher-level window does not comprise a plurality of lower-level windows, and if the first higher-level window has focus, then moving the focus to the second higher-level window;
else if the first higher-level window does not comprise a plurality of lower-level windows, if the second higher-level window comprises a plurality of lower-level windows, the lower-level windows of the second higher-level window ordered from first to last, and if the first higher-level window has focus, then moving the focus to a currently active lower-level window of the second higher-level window;
else if the first higher-level window comprises a plurality of lower-level windows, the lower-level windows of the first higher-level window ordered from first to last, and if a lower-level window of the first higher-level window other than the last lower-level window has focus, then moving the focus to a next lower-level window of the first higher-level window;
else if the first higher-level window comprises a plurality of lower-level windows, the lower-level windows of the first higher-level window ordered from first to last, if the second higher-level window does not comprise a plurality of lower-level windows, and if the last lower-level window of the first higher-level window has focus, then moving the focus to the second higher-level window;
else if the first higher-level window comprises a plurality of lower-level windows, the lower-level windows of the first higher-level window ordered from first to last, if the second higher-level window comprises a plurality of lower-level windows, the lower-level windows of the second higher-level window ordered from first to last, and if the last lower-level window of the first higher-level window has focus, then moving the focus to a currently active lower-level window of the second higher-level window.

16. The computing device of claim 15 wherein the computing device is selected from the group consisting of: a mobile telephone and a personal computer.

17. The computing device of claim 15 wherein the processor is further configured for:
displaying, via the display interface, a plurality of overviews, wherein each overview is associated with a higher-level window.

18. The computing device of claim 15 wherein the processor is further configured for:
before receiving the single forward navigational command, displaying, via the display interface, a first preview associated with a window that currently has focus;
wherein responding to the single forward navigational command further comprises:
ceasing to display the first preview; and
displaying, via the display interface, a second preview associated with the window to which focus is moved.

19. The computing device of claim 18 wherein if the window to which focus is moved is a higher-level window that comprises a plurality of lower-level windows, then displaying the second preview comprises displaying snapshots of those lower-level windows.

20. A computing device configured for switching focus among windows, the computing device comprising:
a display interface configured for displaying a first higher-level window and a second higher-level window;
a keyboard interface configured for receiving a single back navigational command; and
a processor operatively connected to the display interface and to the keyboard interface and configured for responding to the single back navigational command, wherein responding comprises:
if the second higher-level window does not comprise a plurality of lower-level windows, if the first higher-level window does not comprise a plurality of lower-level windows, and if the second higher-level window has focus, then moving the focus to the first higher-level window;
else if the second higher-level window does not comprise a plurality of lower-level windows, if the first higher-level window comprises a plurality of lower-level windows, the lower-level windows of the first higher-level window ordered from first to last, and if the second higher-level window has focus, then moving the focus to a currently active lower-level window of the first higher-level window;
else if the second higher-level window comprises a plurality of lower-level windows, the lower-level windows of the second higher-level window ordered from first to last, and if a lower-level window of the second higher-level window other than the first lower-level window has focus, then moving the focus to a previous lower-level window of the second higher-level window;
else if the second higher-level window comprises a plurality of lower-level windows, the lower-level windows of the second higher-level window ordered from first to last, if the first higher-level window does not comprise a plurality of lower-level windows, and if the first lower-level window of the first higher-level window has focus, then moving the focus to the second higher-level window;
else if the second higher-level window comprises a plurality of lower-level windows, the lower-level windows of the second higher-level window ordered from first to last, if the first higher-level window comprises a plurality of lower-level windows, the lower-level windows of the first higher-level window ordered from first to last, and if the first lower-level window of the second higher-level window has focus, then moving the focus to a currently active lower-level window of the first higher-level window.

21. The computing device of claim 20 wherein the computing device is selected from the group consisting of: a mobile telephone and a personal computer.

22. The computing device of claim 20 wherein the processor is further configured for:
displaying, via the display interface, a plurality of overviews, wherein each overview is associated with a higher-level window.

23. The computing device of claim 20 wherein the processor is further configured for:
before receiving the single back navigational command, displaying, via the display interface, a first preview associated with a window that currently has focus;
wherein responding to the single back navigational command further comprises:
ceasing to display the first preview; and
displaying, via the display interface, a second preview associated with the window to which focus is moved.

24. The computing device of claim 23 wherein if the window to which focus is moved is a higher-level window that comprises a plurality of lower-level windows, then displaying the second preview comprises displaying snapshots of those lower-level windows.
